(19) United States
(12) Patent Application Publication
(10) Pub. No.: US 2012/0101943 A1
(43) Pub. Date: Apr. 26, 2012

(54) E-WALLET SERVICE METHOD BASED ON A WAITING SCREEN APPLICATION

(76) Inventor: Jung Chual Park, Goyang-si (KR)

(21) Appl. No.: 13/258,176

(22) PCT Filed: Mar. 26, 2010
(86) PCT No.: PCT/KR2010/001871

§ 371 Date: Dec. 12, 2011

(30) Foreign Application Priority Data
Mar. 26, 2009 (KR) 10-2009-0025947
Mar. 26, 2010 (KR) 10-2010-0027149

(51) Int. Cl. G06Q 20/36

(52) U.S. Cl. 705/41

(57) ABSTRACT

The present invention provides an E-wallet service method based on a waiting screen application capable of providing payment services for various types of finance company systems through a waiting screen applications installed in various types of terminals without previous registration to finance company.

### BACKGROUND

1. Field of the Invention

The present invention relates to payment service technique, and more particularly to, an E(electronic)-wallet service method based on a waiting screen application which performs payment and payment management through a waiting screen application.

2. Background of the Invention

Generally, in a payment service technique, payment is performed between a seller and a buyer by a payment system or a VAN (value added network) system. As the technique is developed, a next-generation payment system called PAYMENT 2.0 is commercialized as a user-oriented personalized payment service system which provides a payment relaying service.

Among the next-generation payment systems, a payment service called “INI P2P” is provided as a blog-based service. Since there is a limitation in the eligibility, the payment service has not yet widely used in the market. In addition, since a mobile safety service which is currently provided employs SMS(Short Message Service) for reinforcement of security and personalized payment approval, the mobile safety service can be provided through only a mobile communication terminal. Therefore, there is a convenience in that a user necessarily subscribe to a finance company in advance in order to register a payment means.

Accordingly, in the related art, a service technique capable of integrating a plurality of payment means without a complicated procedure and managing information of payment performed by a plurality of the payment means needs to be developed.

### SUMMARY OF THE INVENTION

The present invention provides an E-wallet service method based on a waiting screen application capable of providing payment services for various types of finance company systems through a waiting screen applications installed in various types of terminals without previous registration to finance company.

The present invention also provides an E-wallet service method based on a waiting screen application capable of performing payment request and managing a payment approval result through a waiting screen application.

According to an aspect of the present invention, there is provided an E-wallet service method and system based on a waiting screen application including steps of: in a push module of a push system, receiving a first payment request message including customer identification information, payment object information, and payment amount information from a payment request module and pushing the first payment request message to a customer terminal which a customer is logged in by using the customer identification information; in a waiting screen application installed in the customer terminal, outputting the first payment request message, receiving payment medium information as an input or selecting one of previously-registered payment medium information items if payment according to the first payment request message is requested, generating a second payment request message including the payment medium information, the payment object information, and the payment amount information, and transmitting the second payment request message to a payment approval module of a payment approval system; in the payment approval module, generating a third payment request message having a sales check(slip) format corresponding to the payment medium information included in the second payment request message and including the payment medium information, the payment object information, and the payment amount information, transmitting the third payment request message to a payment system to request payment approval, and transmitting a payment approval result to the customer terminal if the payment approval result according to the third payment request message is supplied from the payment system; and in the waiting screen application installed in the customer terminal, receiving and outputting the payment approval result.

According to the present invention, it is possible to provide payment services for various types of finance company systems through a waiting screen applications installed in various types of terminals without previous registration to finance companies, so that it is possible to greatly improve user's convenience.

In addition, according to the present invention, it is possible to perform payment request and edit a payment approval result through a waiting screen application, and it is possible to manage user-customized payment information.

### BRIEF DESCRIPTION OF THE DRAWINGS

FIG. 1 is a diagram illustrating a configuration of an E-wallet service system based on a waiting screen application according to the present invention.

FIGS. 2 and 3 are flowcharts of an E-wallet service method based on a waiting screen application according to a first embodiment of the present invention.

FIG. 4 is a diagram illustrating an E-wallet service based on a waiting screen application providing screens according to the first embodiment of the present invention.

FIG. 5 is a flowchart of an E-wallet service method based on a waiting screen application according to a second embodiment of the present invention.

### DETAILED DESCRIPTION

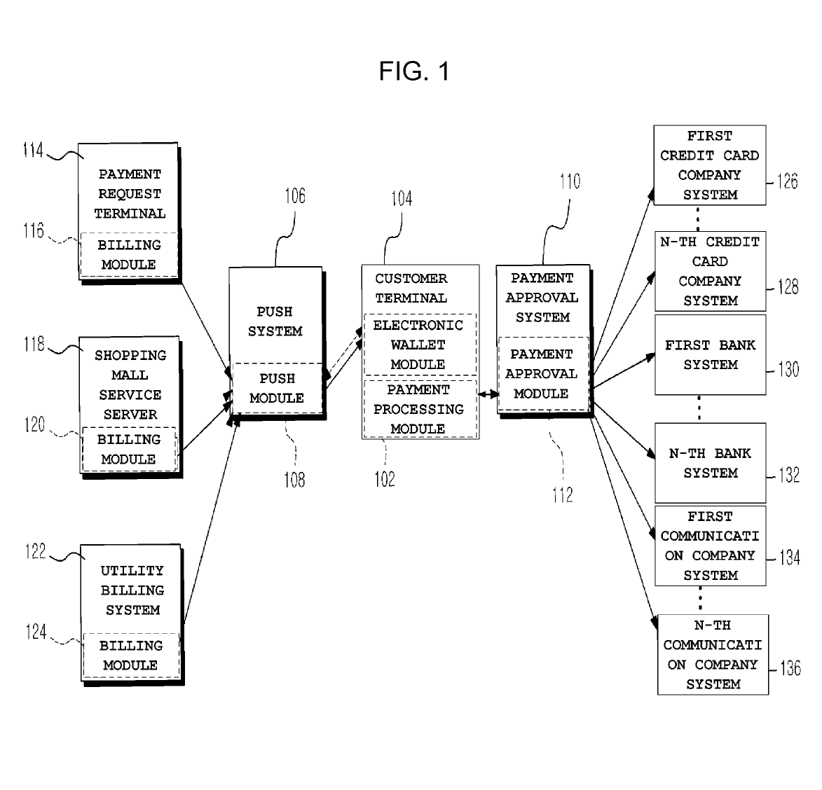

A configuration of an E-wallet service system based on a waiting screen application according to the present invention will be described in detail with reference to FIG. 1.

The E-wallet service system based on a waiting screen application includes an electronic wallet module 100, a payment processing module 102, a push module 108, billing modules 116, 120, and 124, and a payment approval module 112. The electronic wallet module 100 and the payment processing module 102 are configured based on a waiting screen application according to the present invention.

The billing modules 116, 120, and 124 are installed in a payment request terminal 114, a shopping mall service server 118, a utility billing system 122, and the like.

According to the first to third embodiments of the present invention, the billing modules 116, 120, 124 generates first payment request messages including customer identification information, payment object information, payment amount information, and the like which are input by users of the payment request terminal 114, the shopping mall service server 118, and the utility billing system 122 transmits the first payment request messages to the push module 108 installed in a push system 106. In other words, the first payment request message includes customer identification information, payment object information, and payment amount information.

The push module 108 is installed in the push system 106.

According to the first embodiment of the present invention, if the first payment request message is received from the billing modules 116, 120, and 124 installed in the payment request terminal 114, the shopping mall service server 118, the utility billing system 122, or the like, the push module 108 checks based on the customer identification information included in the first payment request message whether or not a customer logs in through a customer terminal 104, and the push module 108 pushes the first payment request message to an electronic wallet module 100 installed in the logged-in customer terminal 104.

In addition, according to the second embodiment of the present invention, if the first payment request message is received from the billing modules 116, 120, and 124 installed in the payment request terminal 114, the shopping mall service server 118, the utility billing system 122, or the like, the push module 108 transmits a notice of reception of the first payment request message to the customer terminal 104 of the customer based on the customer identification information included in the first payment request message. If the customer terminal 104 accesses the push system 106 according to the notice, the push module 108 transmits the first payment request messages formed in the web account of the customer to the customer terminal. Herein, the push module 108 may use an SMS(Short Message Service) server and a push notification server for transmission of the notice.

In addition, the push system 106 stores electronic wallet modules and payment processing modules as waiting screen applications having various skins. The stored electronic wallet modules and payment processing modules are downloaded to the customer terminal 104. The electronic wallet modules may be downloaded at a charge.

In addition, the push system 106 includes an electronic coupon and gift certificate information, which is generated in an image format or various electronic formats, and allows the electronic coupon and the gift certificate information to be downloaded to the customer terminal 104.

In addition, the push system 106 manages customer account information of a customer terminal such as position information, customer identification information (ID), customer terminal identification information (phone number), customer terminal specification information, login information, first payment request messages, and payment approval results, and the customer account information is provided to a customer who accesses a web through the web account.

The electronic wallet module 100 and the payment processing module 102 are waiting screen applications which are downloaded from the push system 106 to be installed in the customer terminal 104. The electronic wallet module 100 and the payment processing module 102 are installed in the customer terminal 104 such as a personal computer, a mobile communication terminal, or a mobile terminal which can be connected to the push system 106 and the payment approval system 110 via wired or wireless network.

According to the first embodiment of the present invention, the electronic wallet module 100 receives and stores the first payment request message pushed by the push module 108 of the push system 106, receives and stores a payment approval result transmitted from the payment processing module 102, selects one of the first payment request messages according to customer's request to request the payment processing module 102 to perform payment approval, receives and stores a payment approval result returned from the payment processing module 102, and edits the first payment request message and the payment approval result according to user's editing request.

In addition, according to the second embodiment of the present invention, if the push module 108 of the push system 106 supplies the first payment request message notice information through an SMS(Short Message Service) server or an push notification server, the electronic wallet module 100 displays the first payment request message notice information on a screen, the electronic wallet module 100 accesses the web account of the user provided by the push module 108 according to user's request, receives and stores the first payment request messages transmitted from the push module 108, selects one of the first payment request messages according to customer's request to request the payment processing module 102 to perform payment approval. The electronic wallet module 100 receives and stores a payment approval result returned from the payment processing module 102 and edits the first payment request message and the payment approval result according to user's editing request.

According to the first and second embodiments of the present invention, the payment processing module 102 generates a second payment request message by adding the payment medium information to the payment request item selected according to the customer's request through the electronic wallet module 100 and provides the second payment request message to the payment approval module 112. If the payment approval result information is supplied through the payment approval module 112, the payment processing module 102 supplies the payment approval result information to the electronic wallet module 100. The payment medium information is information on a credit card or a banking account or information for addition of communication fees or the like. The payment medium information may be input by a customer every payment time. In addition, a plurality of the payment medium information items may be previously registered in a storage medium, a USIM (Universal Subscriber Identity Module), or the like of the customer terminal, and after that, one of the payment medium information items may be selected by the customer. In other words, the second payment request message includes the payment medium information, the customer identification information, the payment object information, and payment amount information,

The payment approval module 112 is installed in the payment approval system 110.

According to the first and second embodiments of the present invention, if the second payment request message is received, the payment approval module 112 generates a third payment request message in a sales check(slip) format corresponding to the payment medium information included in the second payment request message and transmits the generated third payment request message to the credit card company systems 126 to 128, the bank systems 130 and 132, or the communication company systems 134 and 136 corresponding to the payment medium to request payment approval. If information on a payment approval result is supplied from the credit card company systems 126 to 128, the bank systems 130 and 132, or the communication company systems 134 and 136, the payment approval module 112 transmits the payment approval result to the payment processing module 102 installed in the customer terminal 104. In other words, the payment approval module 112 allows different sales check(slip) formats according to the payment medium information to be compatible.

In addition, in the above examples, although the case where the credit card company systems 126 to 128, the bank systems 130 and 132, or the communication company systems 134 and 136 is requested to perform the payment approval through the payment approval system 110 is exemplified, the payment processing module 102 may directly generate a third payment request message in a sales check(slip) format corresponding to a payment medium to request the credit card company systems 126 to 128, the bank systems 130 and 132, or the communication company systems 134 and 136 to perform the payment approval.

In addition, according to the embodiments of the present invention, although the case where the electronic wallet service system is configured with two different hardware components, that is, the push system 106 and the payment approval system 110 is exemplified, the electronic wallet service system may be configured with one hardware component according to the convenience of a service provider.

In addition, according to the first and second embodiments of the present invention, although the case where the push system 106 is configured to download the electronic wallet module 100 is exemplified, a separate management server may be configured to download the electronic wallet module 100.

Now, first and second embodiments of the operations of the waiting screen application based electronic wallet service system configured as described above will be described in detail.

### First Embodiment

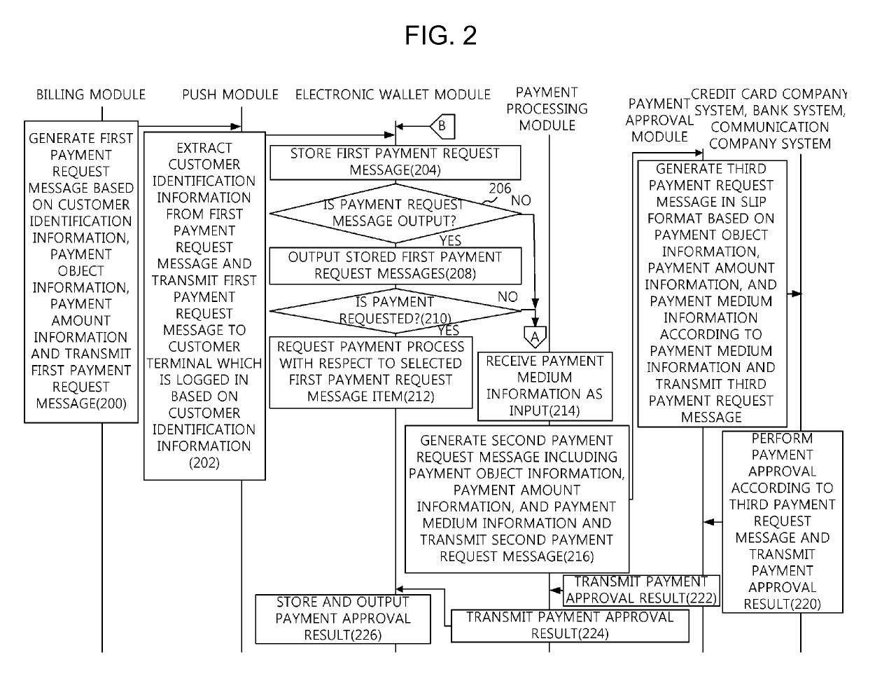

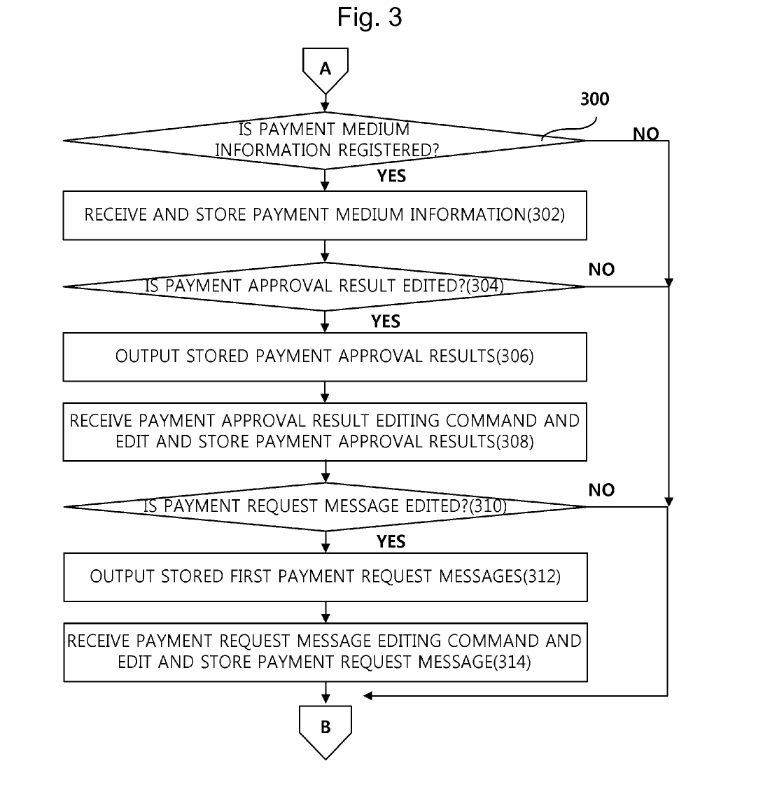

The E-wallet service method based on a waiting screen application according to a first embodiment of the present invention is described with reference to flowcharts of FIGS. 2 and 3.

One of the billing modules 116, 120, and 124 installed in the payment request terminal 114 or the shopping mall service server 118, the utility billing system 122 or the like generates a first payment request message including customer identification information, payment object information, and payment amount information for payment request and transmits the first payment request message to the push module 108 (Step S200).

The push module 108 extracts the customer identification information from the first payment request message and transmits the received first payment request message to the electronic wallet module 100 of the customer terminal which is logged in by the customer identification information (Step S202). Herein, in the case where the customer terminal which is logged in by the customer identification information is not present, the push module 108 transmits a notice of the reception of the first payment request message through an SMS(Short Message Service) server (not shown) or a push notification server (not shown) to the customer terminal of the customer which is registered in advance. If the customer logs in according to the notice, the push module 108 transmits the received first payment request message to the electronic wallet module 100 of the customer terminal which the customer is logged in.

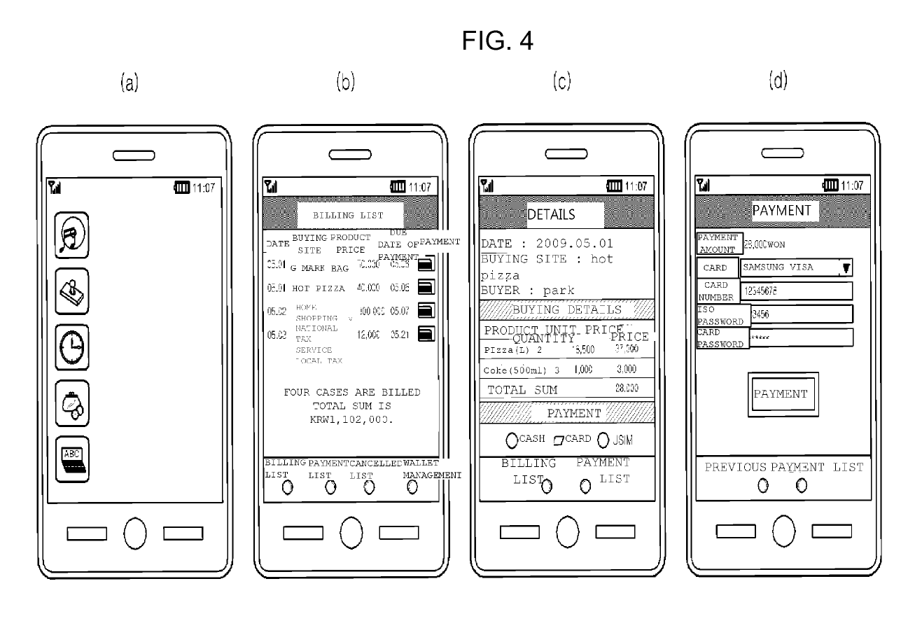

If the first payment request message is received, the electronic wallet module 100 stores the first payment request message and outputs a notice indicating that a new first payment request message is received to a display unit (Step S204). Herein, (a) of FIG. 4 illustrates a screen informing an icon of the electronic wallet module 100 and a notice indicating that a first payment request message is received.

If the output of the payment request message is requested by the customer, the electronic wallet module 100 outputs the stored first payment request messages (Steps S206 and S208). Herein, (b) of FIG. 4 illustrates a screen informing the received first payment request messages.

In the state where the items of the first payment request messages are output, if the customer selects one of the first payment request messages and the payment is requested, the electronic wallet module 100 requests the payment processing module 102 to perform a payment process for the selected item of the first payment request message (Steps S210 and S212). Herein, (c) of FIG. 4 illustrates a screen informing detailed information when the customer selects one of the first payment request messages.

If the payment request occurs, the payment processing module 102 receives the payment medium information or allows one of the payment medium information registered in advance in a USIM (Universal Subscriber Identity Module) or an internal memory to be received and generates a second payment request message including the payment object information, the payment amount information, and the payment medium information and transmits the second payment request message to the payment approval module 112 installed in the payment approval system 110 (Steps S214 and S216). Herein, (d) of FIG. 4 illustrates a screen informing that the customer selects a payment medium for the first payment request message and requests for payment.

If the second payment request message is received, the payment approval module 112 generates a third payment request message in the a sales check(slip) format based on the payment object information, the payment amount information, and the payment medium information according to the payment medium information and transmits the third payment request message to a payment system such as credit card company systems 126 to 128, bank systems 130 and 132, or communication company systems 134 and 136 according to the payment medium information (Step S218).

The payment system such as the credit card company systems 126 to 128, the bank systems 130 and 132, or the communication company systems 134 and 136 performs payment approval according to the third payment request message and transmits a payment approval result as a reply to the payment approval module 112 (Step S220).

The payment approval module 112 transmits the payment approval result to the payment processing module 102, and the payment processing module 102 transmits the payment approval result to the electronic wallet module 100 (Step S222 and S224).

The electronic wallet module 100 stores the payment approval result and outputs the payment approval result to inform the customer (Step S226).

In addition, the electronic wallet module 100 receives and stores the payment medium information according to a request for payment medium information registration issued by the customer (Steps S300 and S302). A plurality of the payment medium information registered are stored in the electronic wallet module 100, so that any one of the payment medium can be selected by the customer.

In addition, the electronic wallet module 100 outputs the stored results of the payment approval according to a request for editing the payment approval result. The electronic wallet module 100 receives editing information such as removing and changing of the payment approval results and performs the editing such as removing or changing of the payment approval results. The electronic wallet module 100 stores the result of the editing (Steps S304 to S308).

In addition, the electronic wallet module 100 outputs the first payment request message stored according to a request for the editing of the payment request message. The electronic wallet module 100 receives editing information such as removing or changing of the first payment request messages and performs editing such as removing or changing of the first payment request message. The electronic wallet module 100 stores the result of the editing (Steps S310 to S314).

### Second Embodiment

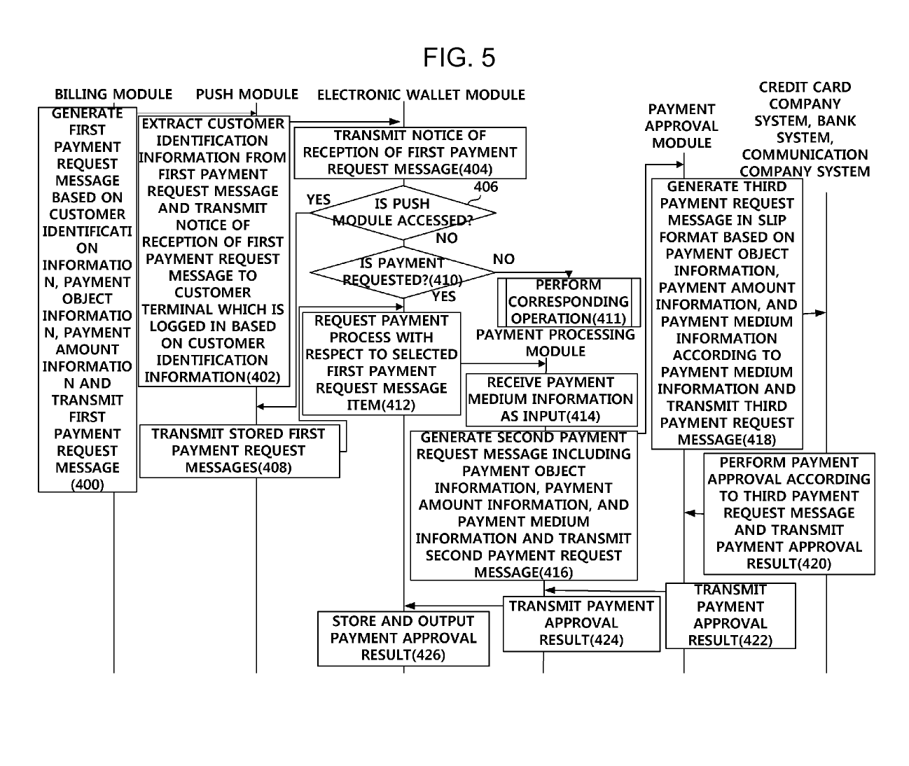

A waiting screen application based electronic wallet service method according to a second embodiment of the present invention is described with reference to a flowchart of FIG. 5.

One of billing modules 116, 120, and 124 installed in a payment request terminal 114, a shopping mall service server 118, a utility billing system 122, or the like generates a first payment request message including customer identification information, payment object information, and payment amount information for payment request and transmits the first payment request message to a push module 108 (Step S400).

The push module 108 extracts customer identification information from the first payment request message and transmits a notice of reception of the first payment request message to the customer terminal registered so as to correspond to the customer identification information (Step S402). The transmission of the notice is performed through an SMS(Short Message Service) server (not shown) or a push notification server (not shown).

The electronic wallet module 100 which receives the notice of reception of the first payment request message displays the notice on the screen so that a customer receives a notice of the reception of the first payment request message (Step S404). As illustrated in (a) of FIG. 4, the notice of the reception may be implemented by displaying the number of the received messages in the vicinity of the electronic wallet driving icon.

If the customer who receives the notice of the reception of the first payment request message requests accessing the push module 108, the electronic wallet module 100 accesses a web account of the customer included in the push module 108 to request a list of the first payment request messages of the customer and receives the list of the first payment request messages (Steps S406 and S408). Herein, the access to the push module 108 may be performed by user double-clicking the electronic wallet driving icon.

Next, the electronic wallet module 100 receives the first payment request messages, and if the customer selects one of the first payment request messages to perform request for payment under the state where the first payment request message items are output, the electronic wallet module 100 requires the payment processing module 102 to perform the payment process with respect to the selected first payment request message item (Steps S410 and S412).

If the payment request occurs, the payment processing module 102 receives the payment medium information as an input or selects one of the payment medium information which is registered in advance in the USIM (Universal Subscriber Identity Module) or the internal memory, generates the second payment request message including the payment object information, the payment amount information, and the payment medium information, and transmits the second payment request message to the payment approval module 112 (Steps S414 and S416).

If the second payment request message is received, the payment approval module 112 generates a third payment request message in the sales check(slip) format according to the payment medium information based on the payment object information, the payment amount information, and the payment medium information and transmits the third payment request message the payment system such as the credit card company systems 126 to 128, the bank systems 130 and 132, or the communication company systems 134 and 136 according to the payment medium information (Step S418).

The payment system such as the credit card company systems 126 to 128, the bank systems 130 and 132, or the communication company systems 134 and 136 performs the payment approval according to the third payment request message and returns the result thereof to the payment approval module 112 (Step S420).

The payment approval module 112 transmits the payment approval result to the payment processing module 102, and the payment processing module 102 transmits the result of the payment approval to the electronic wallet module 100 (Steps S422 and S424).

The electronic wallet module 100 outputs the payment approval result to present the result to the customer (Step S426).

1. An E-wallet service method based on an idle a waiting screen application comprising steps of:
in a push module of a push system, receiving a first payment request message including customer identification information, payment object information, and payment amount information from a payment request module and pushing the first payment request message to a customer terminal which a customer is logged in by using the customer identification information;
in a waiting screen application installed in the customer terminal, outputting the first payment request message, receiving payment medium information as an input or selecting one of previously-registered payment medium information items if payment according to the first payment request message is requested, generating a second payment request message including the payment medium information, the payment object information, and the payment amount information, and transmitting the second payment request message to a payment approval module of a payment approval system;
in the payment approval module, generating a third payment request message having a sales check(slip) format corresponding to the payment medium information included in the second payment request message and including the payment medium information, the payment object information, and the payment amount information, transmitting the third payment request message to a payment system to request payment approval, and transmitting a payment approval result to the customer terminal if the payment approval result according to the third payment request message is supplied from the payment system; and
in the waiting screen application installed in the customer terminal, receiving and outputting the payment approval result.

2. An E-wallet service method based on a waiting screen application comprising steps of:
in a push module of a push system, receiving a first payment request message including customer identification information, payment object information, and payment amount information from a payment request module and pushing the first payment request message to a customer terminal which a customer is logged in by using the customer identification information; and
in a waiting screen application installed in the customer terminal, outputting the first payment request message, receiving payment medium information as an input or selecting one of previously-registered payment medium information items if payment according to the first payment request message is requested, generating a third payment request message having a sales check(slip) format corresponding to the payment medium information and including the payment medium information, the payment object information, and the payment amount information, transmitting the third payment request message to the payment system to request payment approval, and outputting a payment approval result if the payment approval result according to the third payment request message is supplied from the payment system.

3. An E-wallet service method based on a waiting screen application comprising steps of:
in a push module of a push system, transmitting a notice of reception of a first payment request message to a customer terminal if the first payment request message including customer identification information, payment object information, and payment amount information is received from a payment request module;
in a waiting screen application installed in a customer terminal, outputting information according to a notice of reception of the first payment request message, and accessing a web account of a customer included in a push system if the customer requests accessing the push system;
in the push module, transmitting the first payment request messages corresponding to the customer identification information to the customer terminal which accesses the web account of the customer;
in the waiting screen application of the customer terminal, outputting the first payment request messages, receiving payment medium information as an input or selecting one of previously-registered payment medium information items if payment according to one of the first payment request messages is requested, generating a second payment request message including the payment medium information, the payment object information, and the payment amount information, transmitting the second payment request message to a payment approval module of a payment approval system;
in the payment approval module, generating a third payment request message having a sales check(slip) format corresponding to the payment medium information included in the second payment request message and including the payment medium information, the payment object information, and the payment amount information, transmitting the third payment request message to a payment system to request payment approval, and transmitting a payment approval result to the customer terminal if the payment approval result according to the third payment request message is supplied from the payment system; and
in the waiting screen application installed in the customer terminal, receiving and outputting the payment approval result.

4. (canceled)

5. The E-wallet service method based on a waiting screen application according to claim 1, wherein the waiting screen application installed in the customer terminal stores the first payment request message and the payment approval result and removes or changes the stored first payment request message and the stored payment approval result according to user's request for removal or change.

6. The E-wallet service method based on a waiting screen application according to claim 1, wherein the waiting screen application is downloaded from the push system or a predetermined management server to be installed in the customer terminal.

7. The E-wallet service method based on a waiting screen application according to claim 1,
wherein the push system downloads an electronic coupon or a gift certificate from the customer terminal,
wherein the waiting screen application allows the electronic coupon or the gift certificate to be viewed or allows payment amount to be discounted.

8. The E-wallet service method based on a waiting screen application according to claim 1, wherein the payment medium information is stored and registered in a USIM (Universal Subscriber Identity Module) or an internal memory of the customer terminal.

9. The E-wallet service method based on a waiting screen application according to claim 1, wherein the push module transmits a notice of reception of the payment request message to the customer terminal through an SMS(Short Message Service) server or a push notification server.

10. The E-wallet service method based on a waiting screen application according to claim 2, wherein the waiting screen application installed in the customer terminal stores the first payment request message and the payment approval result and removes or changes the stored first payment request message and the stored payment approval result according to user's request for removal or change.

11. The E-wallet service method based on a waiting screen application according to claim 2, wherein the waiting screen application is downloaded from the push system or a predetermined management server to be installed in the customer terminal.

12. The E-wallet service method based on a waiting screen application according to claim 2,
wherein the push system downloads an electronic coupon or a gift certificate from the customer terminal,
wherein the waiting screen application allows the electronic coupon or the gift certificate to be viewed or allows payment amount to be discounted.

13. The E-wallet service method based on a waiting screen application according to claim 2, wherein the payment medium information is stored and registered in a USIM (Universal Subscriber Identity Module) or an internal memory of the customer terminal.

14. The E-wallet service method based on a waiting screen application according to claim 2, wherein the push module transmits a notice of reception of the payment request message to the customer terminal through an SMS(Short Message Service) server or a push notification server.

15. The E-wallet service method based on a waiting screen application according to claim 3, wherein the waiting screen application installed in the customer terminal stores the first payment request message and the payment approval result and removes or changes the stored first payment request message and the stored payment approval result according to user's request for removal or change.

16. The E-wallet service method based on a waiting screen application according to claim 3, wherein the waiting screen application is downloaded from the push system or a predetermined management server to be installed in the customer terminal.

17. The E-wallet service method based on a waiting screen application according to claim 3,
wherein the push system downloads an electronic coupon or a gift certificate from the customer terminal,
wherein the waiting screen application allows the electronic coupon or the gift certificate to be viewed or allows payment amount to be discounted.

18. The E-wallet service method based on a waiting screen application according to claim 3, wherein the payment medium information is stored and registered in a USIM (Universal Subscriber Identity Module) or an internal memory of the customer terminal.

19. The E-wallet service method based on a waiting screen application according to claim 3, wherein the push module transmits a notice of reception of the payment request message to the customer terminal through an SMS(Short Message Service) server or a push notification server.
